(19) United States
(12) Patent Application Publication
(10) Pub. No.: US 2026/0253976 A1
(43) Pub. Date: Aug. 27, 2026

(54) SECONDARY BATTERY AND ELECTRONIC APPARATUS

(71) Applicant: Xiamen Ampace Technology Limited, Xiamen (CN)

(72) Inventors: Chunhua LI, Xiamen (CN); Ye FANG, Xiamen (CN)

(73) Assignee: Xiamen Ampace Technology Limited, Xiamen (CN)

(21) Appl. No.: 19/650,446

(22) Filed: Apr. 17, 2026

Related U.S. Application Data
(63) Continuation of application No. PCT/CN2023/124987, filed on Oct. 17, 2023.

(51) Int. Cl. H01M 10/42; H01M 50/417; H01M 50/426; H01M 50/434; H01M 50/443; H01M 50/446; H01M 50/449; H01M 50/494

(52) U.S. Cl. CPC H01M 10/4235; H01M 50/417; H01M 50/426; H01M 50/434; H01M 50/443; H01M 50/446; H01M 50/449; H01M 50/494

(57) ABSTRACT

A secondary battery includes an electrode assembly. The electrode assembly includes a positive electrode plate, a negative electrode plate, and a separator provided between the positive electrode plate and the negative electrode plate. Tensile strength in transverse direction of the separator is A MPa, puncture strength of the separator is B N/μm, and A and B satisfy: 1.02≤0.1A+0.2B≤2.16, 10≤A≤20, and 0.1≤B≤0.8. The secondary battery of this application has good collision test pass rate and energy density.

### CROSS-REFERENCE TO RELATED APPLICATIONS

This application is a continuation application of International Application No. PCT/CN2023/124987, filed on Oct. 17, 2023, the contents of which is incorporated herein by reference in its entirety.

### TECHNICAL FIELD

This application relates to the field of electrochemical technologies, and in particular, to a secondary battery and an electronic apparatus.

### BACKGROUND

Cylindrical secondary batteries (such as lithium-ion batteries) have advantages of standardization, high automation, low costs, good consistency, and high energy density, and can be applied to irregular housings in practical use and are widely used. However, cylindrical secondary batteries also have their own problems. For example, during vibration and collision tests, cylindrical secondary batteries may fail due to axial movement.

The pass rate of existing cylindrical secondary batteries in collision tests is generally increased by using expansion ending adhesive paper to increase friction. However, this solution leads to a decrease in the energy density of the cylindrical secondary batteries. Therefore, development of a new technical solution to increase the collision test pass rate of cylindrical secondary batteries has become an urgent technical problem that needs to be solved by persons skilled in the art.

### SUMMARY

This application is intended to provide a secondary battery and an electronic apparatus so as to increase the collision test pass rate of the secondary battery while taking into account the energy density.

It should be noted that in the summary of this application, a lithium-ion battery is used as an example of a secondary battery to explain this application. However, the secondary battery of this application is not limited to the lithium-ion battery. Specific technical solutions are as follows:

A first aspect of this application provides a secondary battery, including an electrode assembly, where the electrode assembly includes a positive electrode plate, a negative electrode plate, and a separator provided between the positive electrode plate and the negative electrode plate; where tensile strength in transverse direction of the separator is A MPa, puncture strength of the separator is B N/μm, and A and B satisfy: 1.02≤0.1A+0.2B≤2.16, 10≤A≤20, and 0.1≤B≤0.8. Regulating the tensile strength in transverse direction and puncture strength of the separator within the above ranges and making the tensile strength in transverse direction and puncture strength of the separator satisfy 1.02≤0.1A+0.2B≤2.16 in this application allow the separator to have good strength and toughness when the secondary battery is subjected to conditions such as collision or drop, so as to buffer the impact force inside the secondary battery, provide good protection for the electrode assembly, and reduce the risk of deformation and failure of the electrode assembly, thereby increasing the collision test pass rate of the secondary battery while taking into account the energy density, and making the secondary battery have good safety performance and high energy density.

In an embodiment of this application, 1.1≤0.1A+0.2B≤1.6.

In an embodiment of this application, 11≤A≤15.

In an embodiment of this application, 0.2≤B≤0.6.

In an embodiment of this application, the positive electrode plate includes a positive electrode current collector, tensile strength of the positive electrode current collector is C MPa, and A and C satisfy: 0.048≤A/C≤0.25. Regulating the value of A/C within the above range helps enable the secondary battery to have a high collision test pass rate while taking into account the energy density.

In an embodiment of this application, 80≤C≤250.

In an embodiment of this application, based on a volume of the electrode assembly, a volume percentage of the separator is 6% to 14%. Regulating the volume percentage of the separator within the above range can increase the collision test pass rate of the secondary battery while taking into account the energy density of the secondary battery, and make the secondary battery have good safety performance and high energy density.

In an embodiment of this application, based on a volume of the electrode assembly, a volume percentage of the separator is 7% to 10%. Regulating the volume percentage of the separator within the above range can further increase the collision test pass rate of the secondary battery while taking into account the energy density of the secondary battery.

In an embodiment of this application, the separator includes a substrate film and an inorganic coating provided on at least one surface of the substrate film. The substrate film includes at least one of polypropylene or polyethylene. The inorganic coating includes inorganic particles and a coating binder. The inorganic particles include at least one of aluminum oxide, bochmite, titanium dioxide, silicon dioxide, zirconium dioxide, tin dioxide, magnesium hydroxide, magnesium oxide, zinc oxide, barium sulfate, boron nitride, or aluminum nitride. The coating binder includes at least one of polyvinylidene fluoride, polyacrylic acid, polymethyl methacrylate, polybutyl acrylate, or polyacrylonitrile.

In an embodiment of this application, a thickness of the substrate film is 7 μm to 19 μm, and a total thickness of the inorganic coating is 0.5 μm to 7 μm. Regulating the thicknesses of the substrate film and the inorganic coating within the above ranges enables the separator to have good tensile strength in transverse direction and puncture strength, and allows the separator to have good strength and toughness when the secondary battery is subjected to conditions such as collision or drop, so as to buffer the impact force inside the secondary battery, provide good protection for the electrode assembly, and reduce the risk of deformation and failure of the electrode assembly, thereby increasing the collision test pass rate of the secondary battery while taking into account the energy density of the secondary battery, and making the secondary battery have good safety performance and high energy density.

In an embodiment of this application, the thickness of the substrate film is 9 μm to 15 μm; and/or the total thickness of the inorganic coating is 1 μm to 4 μm. Regulating the thicknesses of the substrate film and/or the inorganic coating within the above ranges can further enhance the tensile strength in transverse direction and puncture strength of the separator, thereby facilitating further increase of the collision test pass rate of the secondary battery while taking into account the energy density of the secondary battery.

A second aspect of this application provides an electronic apparatus, where the electronic apparatus includes the secondary battery according to any one of the foregoing embodiments. Therefore, the electronic apparatus has good safety performance.

Beneficial effects of the embodiments of this application are as follows:

The embodiments of this application provide a secondary battery and an electronic apparatus. For the secondary battery, the tensile strength in transverse direction and puncture strength of the separator are regulated within the above ranges and the tensile strength in transverse direction and puncture strength of the separator satisfy 1.02≤0.1A+0.2B≤2.16, enabling the separator to have good strength and toughness when the secondary battery is subjected to conditions such as collision or drop, so as to buffer the impact force inside the secondary battery, provide good protection for the electrode assembly, and reduce the risk of deformation and failure of the electrode assembly, thereby increasing the collision test pass rate of the secondary battery while taking into account the energy density, and making the secondary battery have good safety performance and high energy density.

### BRIEF DESCRIPTION OF DRAWINGS

The accompanying drawings described herein are intended for better understanding of this application and constitute a part of this application. Illustrative embodiments and descriptions thereof in this application are intended to interpret this application without constituting any inappropriate limitation on this application.

FIG. 1 is a schematic diagram showing a sectional structure of a separator along its thickness direction according to an embodiment of this application.

### DETAILED DESCRIPTION

To make the objectives, technical solutions, and advantages of this application clearer, the following describes this application in detail with reference to accompanying drawings and embodiments. Apparently, the described embodiments are only some rather than all of the embodiments of this application. All other embodiments obtained by persons of ordinary skill in the art based on this application shall fall within the protection scope of this application.

It should be noted that in specific embodiments of this application, an example in which a lithium-ion battery is used as a secondary battery is used to illustrate this application. However, the secondary battery in this application is not limited to the lithium-ion battery. Specific technical solutions are as follows:

A first aspect of this application provides a secondary battery, including an electrode assembly, where the electrode assembly includes a positive electrode plate, a negative electrode plate, and a separator provided between the positive electrode plate and the negative electrode plate; where tensile strength in transverse direction of the separator is A MPa, puncture strength of the separator is B N/μm, and A and B satisfy: 1.02≤0.1A+0.2B≤2.16, 10≤A≤20, and 0.1≤B≤0.8.

For example, the value of 0.1A+0.2B is 1.02, 1.1, 1.2, 1.3, 1.4, 1.5, 1.6, 1.7, 1.8, 1.9, 2.0, 2.1, 2.16, or any value within a range defined by any two of the above values. For example, A is 10, 11, 12, 13, 14, 15, 16, 17, 18, 19, 20, or any value within a range defined by any two of the above values. For example, B is 0.1, 0.2, 0.3, 0.4, 0.5, 0.6, 0.7, 0.8, or any value within a range defined by any two of the above values. If the tensile strength in transverse direction of the separator is less than 10 MPa, the tensile strength in transverse direction of the separator is excessively low, and the separator is easy to break under conditions such as collision or drop of the secondary battery, thereby affecting the collision test pass rate of the secondary battery. If the tensile strength in transverse direction of the separator is greater than 20 MPa, the tensile strength in transverse direction of the separator is excessively high, which will lead to poor toughness of the separator and poor buffering ability of the separator for the impact force generated under conditions such as collision or drop of the secondary battery, and the secondary battery is prone to deformation and failure, thereby affecting the collision test pass rate of the secondary battery. If the puncture strength of the separator is less than 0.1 N/μm, the puncture strength of the separator is excessively low, and when the secondary battery is subjected to impact force generated under conditions such as collision or drop, the strength of the separator is insufficient, and the impact force that can be offset is small, which will cause damage to the electrode assembly, contact between the positive electrode plate and the negative electrode plate, and thus failure of the secondary battery. If the puncture strength of the separator is greater than 0.8 N/μm, the puncture strength of the separator is excessively high, leading to poor toughness of the separator and poor buffering ability of the separator, and the secondary battery is prone to deformation and failure, thereby affecting the collision test pass rate of the secondary battery. If the value of 0.1A+0.2B is less than 1.02, both the tensile strength in transverse direction and puncture strength of the separator are excessively low, and under conditions such as collision or drop of the secondary battery, the separator is easy to break or has insufficient strength, which will cause damage to the electrode assembly, contact between the positive electrode plate and the negative electrode plate, and thus failure of the secondary battery. If the value of 0.1A+0.2B is greater than 2.16, both the tensile strength in transverse direction and puncture strength of the separator are excessively high, which will lead to poor toughness of the separator, and poor buffering ability of the separator for the impact force generated under conditions such as collision or drop of the secondary battery, and the secondary battery is prone to deformation and failure, thereby affecting the collision test pass rate of the secondary battery. Regulating the tensile strength in transverse direction and puncture strength of the separator within the above ranges and making the tensile strength in transverse direction and puncture strength of the separator satisfy 1.02≤0.1A+0.2B≤2.16 in this application allow the separator to have good strength and toughness without increasing the thickness when the secondary battery is subjected to conditions such as collision or drop, so as to buffer the impact force inside the secondary battery, provide good protection for the electrode assembly, and reduce the risk of deformation and failure of the electrode assembly, thereby increasing the collision test pass rate of the secondary battery while taking into account the energy density, and making the secondary battery have good safety performance and high energy density.

In this application, the tensile strength in transverse direction is the tensile strength in transverse direction commonly known in the art. This application does not particularly limit the regulation manner of the tensile strength in transverse direction of the separator, provided that the objectives of this application can be achieved. For example, such regulation can be achieved by regulating the thickness of the substrate film in the separator.

In this application, the puncture strength is the puncture strength commonly known in the art. This application does not particularly limit the regulation manner of the puncture strength of the separator, provided that the objectives of this application can be achieved. For example, such regulation can be achieved by regulating the thickness of the inorganic coating in the separator.

In an embodiment of this application, 1.1≤0.1A+0.2B≤1.6. For example, the value of 0.1A+0.2B is 1.1, 1.2, 1.3, 1.4, 1.5, 1.6, or any value within a range defined by any two of the above values. Regulating the value of 0.1A+0.2B within the above range can regulate the overall strength and rigidity of the secondary battery, enable the secondary battery to have better collision-proof effect under conditions such as collision or drop, and also reduce the risk of protrusion of positive electrode active material or negative active material caused by external force which in turn leads to puncture of the separator and failure, thereby facilitating further increase of the collision test pass rate of the secondary battery while taking into account the energy density of the secondary battery.

In an embodiment of this application, 11≤A≤15. For example, A is 11, 12, 13, 14, 15, or any value within a range defined by any two of the above values. Regulating the tensile strength in transverse direction of the separator within the above range results in small deformation of the separator, low probability of breakage, and low possibility of brittle fracture when the separator is extruded, thereby facilitating further increase of the collision test pass rate of the secondary battery while taking into account the energy density of the secondary battery.

In an embodiment of this application, 0.2≤B≤0.6. For example, B is 0.2, 0.3, 0.4, 0.5, 0.6, or any value within a range defined by any two of the above values. Regulating the puncture strength of the separator within the above range results in small deformation of the separator, low probability of breakage, and low possibility of brittle fracture when the separator is extruded, thereby facilitating further increase of the collision test pass rate of the secondary battery while taking into account the energy density of the secondary battery.

In an embodiment of this application, the positive electrode plate includes a positive electrode current collector, tensile strength of the positive electrode current collector is C MPa, and A and C satisfy: 0.048≤A/C≤0.25. For example, the value of A/C is 0.048, 0.1, 0.15, 0.2, 0.25, or any value within a range defined by any two of the above values. Regulating the value of A/C within the above range results in a small difference between the tensile strength in transverse direction of the separator and the mechanical performance of the positive electrode current collector, low risk of breakage of the separator. Moreover, the separator can have a relatively appropriate tensile strength in transverse direction, reducing the probability of brittle fracture during impact-caused deformation of the secondary battery under conditions such as collision or drop, or puncture of the separator by positive or negative active material particles or burrs of the positive electrode current collector which in turn leads to failure of the secondary battery, which helps increase the collision test pass rate of the secondary battery while taking into account the energy density.

In an embodiment of this application, the tensile strength C of the positive electrode current collector is 80 MPa to 250 MPa. For example, the tensile strength of the positive electrode current collector is 80 MPa, 100 MPa, 130 MPa, 160 MPa, 190 MPa, 220 MPa, 250 MPa, or any value within a range defined by any two of the above values. Regulating the tensile strength of the positive electrode current collector within the above range is conducive to increasing the collision test pass rate of the secondary battery while taking into account the energy density.

This application does not particularly limit the regulation manner of the tensile strength of the positive electrode current collector, provided that the objectives of this application can be achieved. For example, such regulation can be achieved by regulating at least one of the material grade or temper of the positive electrode current collector, in accordance with the standard GB/T 3198-2010 Aluminum and aluminum alloys foils for the material grade or temper.

In an embodiment of this application, based on a volume of the electrode assembly, a volume percentage of the separator is 6% to 14%. For example, the volume percentage of the separator is 6%, 7%, 8%, 9%, 10%, 11%, 12%, 13%, 14%, or any value within a range defined by any two of the above values. Regulating the volume percentage of the separator within the above range enables the secondary battery to have appropriate impedance while the separator provides good protection for the electrode assembly, reduces the risk of lithium precipitation on the negative electrode plate during charge and discharge of the secondary battery, thereby reducing the risk of internal short circuit caused by lithium precipitation which in turn leads to failure of the secondary battery. In this way, the collision test pass rate of the secondary battery can be increased while taking into account the energy density of the secondary battery, and the secondary battery has good safety performance and high energy density.

In an embodiment of this application, based on a volume of the electrode assembly, a volume percentage of the separator is 7% to 10%. For example, the volume percentage of the separator is 7%, 8%, 9%, 10%, or any value within a range defined by any two of the above values. Regulating the volume percentage of the separator within the above range can further increase the collision test pass rate of the secondary battery while taking into account the energy density of the secondary battery.

This application does not particularly limit the regulation manner of the volume percentage of the separator, provided that the objectives of this application can be achieved. For example, such regulation can be achieved by regulating at least one of the thickness of the separator, the thickness of the positive electrode plate, or the thickness of the negative electrode plate.

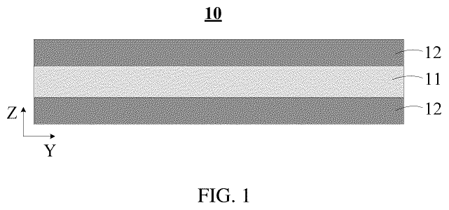

In an embodiment of this application, the separator includes a substrate film and an inorganic coating provided on at least one surface of the substrate film. The above “inorganic coating provided on at least one surface of the substrate film” means that the inorganic coating can be provided on both surfaces of the substrate film or on one surface of the substrate film. For ease of understanding, in this application, a length direction and thickness direction of the separator are defined as Y and Z respectively. It should be understood that the above definitions of directions are for convenience of describing the objectives of this application and can be understood according to the relative positions of elements in the accompanying drawings and actual products. Moreover, the length directions and thickness directions of the substrate film and the inorganic coating are the same as those of the separator. For example, as shown in FIG. 1, a separator 10 includes a substrate film 11 and inorganic coatings 12 provided on both surfaces of the substrate film 11. Certainly, in some embodiments, the separator includes a substrate film and an inorganic coating provided on one surface of the substrate film. The substrate film includes at least one of polypropylene or polyethylene. The inorganic coating includes inorganic particles and a coating binder. The inorganic particles include at least one of aluminum oxide, boehmite, titanium dioxide, silicon dioxide, zirconium dioxide, tin dioxide, magnesium hydroxide, magnesium oxide, zinc oxide, barium sulfate, boron nitride, or aluminum nitride. The coating binder includes at least one of polyvinylidene fluoride, polyacrylic acid, polymethyl methacrylate, polybutyl acrylate, or polyacrylonitrile. The above types of separators allow for good tensile strength in transverse direction and puncture strength, enable the separator to have good strength and toughness when the secondary battery is subjected to conditions such as collision or drop, so as to buffer the impact force inside the secondary battery, provide good protection for the electrode assembly, and reduce the risk of deformation and failure of the electrode assembly, thereby increasing the collision test pass rate of the secondary battery while taking into account the energy density of the secondary battery, and making the secondary battery have good safety performance and high energy density.

In an embodiment of this application, based on a mass of the inorganic coating, a mass percentage of the inorganic particles is 45% to 55%, and a mass percentage of the coating binder is 45% to 55%.

In an embodiment of this application, Dᵥ50 of the inorganic particles is 0.5 μm to 1.4 μm. In this application, Dᵥ50 represents a particle size of the inorganic particles where the cumulative volume by volume reaches 50% as counted from the small particle size side. This application does not particularly limit the method for measuring Dᵥ50 of the inorganic particles, provided that the objectives of this application can be achieved. For example, a laser particle size analyzer (for example, Malvern Master Size 3000) is used for measuring Dᵥ50 in accordance with the national standard GB/T 19077-2016 (particle size distribution laser diffraction method).

In an embodiment of this application, a thickness of the substrate film is 7 μm to 19 μm, and a total thickness of the inorganic coating is 0.5 μm to 7 μm. For example, the thickness of the substrate film is 7 μm, 9 μm, 11 μm, 13 μm, 15 μm, 17 μm, 19 μm, or any value within a range defined by any two of the above values. For example, the total thickness of the inorganic coating is 0.5 μm, 1 μm, 2 μm, 3 μm, 4 μm, 5 μm, 6 μm, 7 μm, or any value within a range defined by any two of the above values. It should be noted that the above “total thickness of the inorganic coating” refers to the sum of the thicknesses of the inorganic coatings in the separator. For example, in some embodiments, the inorganic coating is provided on one surface of the substrate film, and the separator contains a single layer of inorganic coating, then the total thickness of the inorganic coating is the thickness of the single layer of inorganic coating. In some other embodiments, the inorganic coating is provided on both surfaces of the substrate film, and the separator contains double layers of inorganic coatings, then the total thickness of the inorganic coatings includes the thicknesses of the double layers of inorganic coatings. Regulating the thicknesses of the substrate film and the inorganic coating within the above ranges enables the separator to have good tensile strength in transverse direction and puncture strength, and allows the separator to have good strength and toughness when the secondary battery is subjected to conditions such as collision or drop, so as to buffer the impact force inside the secondary battery, provide good protection for the electrode assembly, and reduce the risk of deformation and failure of the electrode assembly, thereby increasing the collision test pass rate of the secondary battery, and making the secondary battery have good safety performance.

In an embodiment of this application, the thickness of the substrate film is 9 μm to 15 μm. For example, the thickness of the substrate film is 9 μm, 10 μm, 11 μm, 12 μm, 13 μm, 14 μm, 15 μm, or any value within a range defined by any two of the above values. Regulating the thickness of the substrate film within the above range can further enhance the tensile strength in transverse direction of the separator and make the separator have an appropriate thickness, which can reduce the probability of loss in the energy density of the secondary battery due to increased separator thickness, thereby facilitating further increase of the collision test pass rate of the secondary battery while taking into account the energy density of the secondary battery.

In an embodiment of this application, the total thickness of the inorganic coating is 1 μm to 4 μm. For example, the total thickness of the inorganic coating is 1 μm, 2 μm, 3 μm, 4 μm, or any value within a range defined by any two of the above values. Regulating the thickness of the inorganic coating within the above range can further enhance the puncture strength of the separator and make the separator have an appropriate thickness, which can reduce the probability of loss in the energy density of the secondary battery due to increased separator thickness, thereby facilitating further increase of the collision test pass rate of the secondary battery while taking into account the energy density of the secondary battery.

In an embodiment of this application, the thickness of the substrate film is 9 μm to 15 μm, and the total thickness of the inorganic coating is 1 μm to 4 μm. For example, the thickness of the substrate film is 9 μm, 10 μm, 11 μm, 12 μm, 13 μm, 14 μm, 15 μm, or any value within a range defined by any two of the above values. The total thickness of the inorganic coating is 1 μm, 2 μm, 3 μm, 4 μm, or any value within a range defined by any two of the above values. Regulating the thicknesses of the substrate film and the inorganic coating within the above ranges can further enhance the tensile strength in transverse direction and puncture strength of the separator and make the separator have an appropriate thickness, which can reduce the probability of loss in the energy density of the secondary battery due to increased separator thickness, thereby facilitating further increase of the collision test pass rate of the secondary battery while taking into account the energy density of the secondary battery.

This application does not particularly limit the positive electrode plate, provided that the objectives of this application can be achieved. For example, the positive electrode plate includes a positive electrode current collector and a positive electrode active material layer provided on at least one surface of the positive electrode current collector. In some embodiments, the positive electrode active material layer is provided on one surface of the positive electrode current collector. In some other embodiments, the positive electrode active material layer is provided on both surfaces of the positive electrode current collector. The above “surface” may be part of the surface or the entire surface of the positive electrode current collector. This application does not particularly limit the type of the positive electrode current collector, provided that the objectives of this application can be achieved. For example, the positive electrode current collector may include aluminum foil, aluminum alloy foil, or the like. The positive electrode active material layer in this application includes a positive electrode active material. This application does not particularly limit the type of the positive electrode active material, provided that the material includes a transition metal element in this application and the objectives of this application can be achieved. For example, the positive electrode active material may include at least one of lithium nickel cobalt manganate (LiNi_{0.8}Co_{0.1}Mn_{0.1}O₂), lithium nickel cobalt aluminate, lithium iron phosphate, lithium-rich manganese-based materials, lithium cobalt oxide (LiCoO₂), lithium manganate, lithium iron manganese phosphate, or lithium titanate. In this application, the positive electrode active material may further include a non-metal element. For example, the non-metal element includes at least one of fluorine, phosphorus, boron, chlorine, silicon, or sulfur. These elements can further improve stability of the positive electrode active material. In this application, the thicknesses of the positive electrode current collector and the positive electrode active material layer are not particularly limited, provided that the objectives of this application can be achieved. For example, the thickness of the positive electrode current collector is 5 μm to 20 μm, and further, the thickness of the positive electrode current collector may be 6 μm to 18 μm. The thickness of the positive electrode active material layer is 30 μm to 120 μm.

Optionally, the positive electrode active material layer may further include a positive conductive agent and a positive electrode binder. This application does not particularly limit the types of the positive conductive agent and the positive electrode binder in the positive electrode active material layer, provided that the objectives of this application can be achieved. This application does not particularly limit the mass ratio of the positive electrode active material, positive conductive agent, and positive electrode binder in the positive electrode active material layer, and persons of ordinary skill in the art can make a selection based on actual needs, provided that the objectives of this application can be achieved. For example, the mass ratio of the positive electrode active material, positive conductive agent, and positive electrode binder in the positive electrode active material layer is (95-98):(0.5-2.5):(1.5-3.4).

This application does not particularly limit the negative electrode plate, provided that the objectives of this application can be achieved. For example, the negative electrode plate includes a negative electrode current collector and a negative electrode active material layer provided on at least one surface of the negative electrode current collector. In some embodiments, the negative electrode active material layer is provided on one surface of the negative electrode current collector. In some other embodiments, the negative electrode active material layer is provided on both surfaces of the negative electrode current collector. The above “surface” may be part of the surface or the entire surface of the negative electrode current collector. The negative electrode active material layer in this application contains a negative electrode active material. This application does not particularly limit the type of the negative electrode active material, provided that the objectives of this application can be achieved. For example, the negative electrode active material may include at least one of natural graphite, artificial graphite, a mesocarbon microbead (MCMB), hard carbon, soft carbon, silicon, a silicon-carbon composite, SiOₓ (0<x<2), a Li—Sn alloy, a Li—Sn—O alloy, Sn, SnO, SnO₂, a Li—Al alloy, or lithium metal. In this application, the thicknesses of the negative electrode current collector and the negative electrode active material layer are not particularly limited, provided that the objectives of this application can be achieved. For example, the thickness of the negative electrode current collector is 6 μm to 10 μm, and the thickness of the negative electrode active material layer is 30 μm to 130 μm.

Optionally, the negative electrode active material layer may further include at least one of a negative conductive agent, a thickener, or a negative electrode binder. This application does not particularly limit the types of the negative conductive agent, the thickener, and the negative electrode binder in the negative electrode active material layer, provided that the objectives of this application can be achieved. This application does not particularly limit the mass ratio of the negative electrode active material, negative conductive agent, thickener, and negative electrode binder in the negative electrode active material layer, provided that the objectives of this application can be achieved. For example, the mass ratio of the negative electrode active material, negative conductive agent, thickener, and negative electrode binder in the negative electrode active material layer is (96-98):(0.5-2):(0-1.5):(1.0-1.9).

In an embodiment of this application, the secondary battery further includes an electrolyte and a housing. This application does not particularly limit the electrolyte and the housing, which can be electrolytes and housings commonly known in the art, provided that the objectives of this application can be achieved.

The secondary battery is not limited to any particular type in this application, which may include any apparatus in which an electrochemical reaction occurs. For example, the secondary battery may include but is not limited to a lithium metal secondary battery, a lithium-ion secondary battery (lithium-ion battery), a sodium-ion secondary battery (sodium-ion battery), a lithium polymer secondary battery, or a lithium-ion polymer secondary battery.

This application does not particularly limit the preparation method of the separator, and a preparation method commonly known in the art can be selected, provided that the objectives of this application can be achieved.

For example, in an embodiment, the preparation method of the separator includes but is not limited to the following steps: (1) mixing inorganic particles and a coating binder to uniformity to obtain an inorganic coating slurry with a solid content of 50 wt % to 55 wt %; and (2) applying the inorganic coating slurry on one surface of the substrate film, followed by drying to form an inorganic coating, so as to obtain the separator. This application does not particularly limit the drying temperature and time in step (2), and persons of ordinary skill in the art can make a selection and an adjustment based on actual needs, provided that the objectives of this application can be achieved.

For example, in another embodiment, the preparation method of the separator includes but is not limited to the following steps: (1) mixing inorganic particles and a coating binder to uniformity to obtain an inorganic coating slurry with a solid content of 50 wt % to 55 wt %; (2) applying the inorganic coating slurry on one surface of the substrate film, followed by drying to form a single layer of inorganic coating; and (3) applying the inorganic coating slurry on the other surface of the substrate film, followed by drying to form double layers of inorganic coatings, so as to obtain the separator. This application does not particularly limit the drying temperatures and times in steps (2) and (3), and persons of ordinary skill in the art can make a selection and an adjustment based on actual needs, provided that the objectives of this application can be achieved.

This application does not particularly limit the preparation method of the secondary battery, and a preparation method commonly known in the art can be selected, provided that the objectives of this application can be achieved. For example, the preparation method of the secondary battery includes but is not limited to the following steps: stacking the positive electrode plate, the separator, and the negative electrode plate in sequence, and performing operations such as winding and folding on the stack as required to obtain an electrode assembly having a winding structure, placing the electrode assembly into a housing, injecting an electrolyte into the housing and sealing the housing to obtain the secondary battery; or laminating the positive electrode plate, the separator, and the negative electrode plate in sequence, fixing four corners of the overall laminated structure to obtain an electrode assembly having a laminated structure, placing the electrode assembly into a housing, injecting an electrolyte into the housing and sealing the housing to obtain the secondary battery.

A second aspect of this application provides an electronic apparatus, where the electronic apparatus includes the secondary battery according to any one of the foregoing embodiments. Therefore, the electronic apparatus has good safety performance.

The electronic apparatus in this application is not particularly limited and may be any electronic apparatus used in the prior art. For example, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal display television, a portable cleaner, a portable CD player, a mini-disc player, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, or a lithium-ion capacitor.

### EXAMPLES

The following describes the embodiments of this application more specifically by using examples and comparative examples. Various tests and evaluations are performed in the following methods.

### Test Methods and Equipment

### Test for Tensile Strength in Transverse Direction a of the Separator:

The lithium-ion battery was disassembled to obtain the separator. The separator was immersed in a dimethyl carbonate (DMC) solution for 2 h, dried, and then tested according to the national standard GB/T 36363-2018 Polyolefin separator for lithium-ion battery.

During the test, the width direction of the separator in the unfolded state was defined as the transverse direction.

### Test for Puncture Strength B of the Separator:

The lithium-ion battery was disassembled to obtain the separator. The separator was immersed in a DMC solution for 2 h, dried, and then tested according to the national standard GB/T 36363-2018 Polyolefin separator for lithium-ion battery.

### Test for Tensile Strength C of the Positive Electrode Current Collector:

(1) The lithium-ion battery was disassembled to obtain the positive electrode plate, and the positive electrode active material layer was wiped off with N-methylpyrrolidone (NMP) to obtain the positive electrode current collector.

(2) Tests were performed according to YB/T 4334-2013 Metal foil-Method of tensile testing at room temperature and GB/T 228-2010 Metallic materials-Tensile testing—Part 1: Method of test at room temperature.

### Measurement and Calculation of Volume Percentage of the Separator:

The fully discharged lithium-ion battery was disassembled to obtain the positive electrode plate, negative electrode plate, and separator. The positive electrode plate, negative electrode plate, and separator were separately washed in a freshly opened DMC solution, dried, and then measured and calculated as follows:
(1) Calculation of separator volume: The width W₁ of the separator was measured using an optical microscope, the length L₁ of the separator was measured using a soft ruler, and the thickness T₁ of the separator was measured using a micrometer. The volume V₁ of the separator=W₁×L₁×T₁.
(2) Calculation of electrode assembly volume: The widths W₂ of the positive electrode plate and W₃ of the negative electrode plate were separately measured using the optical microscope, the lengths L₂ of the positive electrode plate and L₃ of the negative electrode plate were separately measured using the soft ruler, the thicknesses T₂ of the positive electrode plate and T₃ of the negative electrode plate were separately measured using the micrometer;
the volume V₂ of the positive electrode plate=W₂×L₂×T₂, the volume V₃ of the negative electrode plate=W₃×L₃×T₃; and
the volume V₄ of the electrode assembly=V₁+V₂+V₃.
(3) Volume percentage (%) of the separator=V1/V4×100%.

### Collision Test for Pass Rate:

Each lithium-ion battery in the examples and comparative examples was charged at a constant current of 2C to 4.2 V, then charged at a constant voltage of 4.2 V to 0.05 C, to enter a fully charged state. The fully charged lithium-ion battery was placed on the test bench, a round bar with a diameter of φ15.8 mm and a length of 15.8 cm was placed at the center of the wide surface of the lithium-ion battery, and the longitudinal axis of the lithium-ion battery and the longitudinal axis of the round bar were both parallel to the surface of the test bench and the longitudinal axis of the lithium-ion battery was perpendicular to the longitudinal axis of the round bar (forming a cross). A 9.1 kg hammer was dropped vertically from a height of 610 mm in a free state, falling at the intersection of the round bar and the lithium-ion battery. The above lithium-ion battery was a cylindrical lithium-ion battery.

Judgment standard: the battery passes the test if neither fire, explosion, nor leakage occurs.

20 lithium-ion batteries were tested for each example or comparative example, and the collision test pass rate=number of passes/20.

### Test for Energy Density:

The lithium-ion battery was charged according to the following operation process, and then discharged to obtain the discharge capacity of the lithium-ion battery.

Charging: The battery was charged at a constant current of 2C to 4.2 V, and then charged at a constant voltage of 4.2 V to 0.05 C.

Discharging: The battery was discharged at a constant current of 0.2 C to 2.5 V to obtain the discharge energy E1.

After the charging step of the lithium-ion battery was completed, the length L, width W, and height H of the lithium-ion battery were measured using a laser thickness gauge to obtain the volume V of the lithium-ion battery=L×W×H. The volumetric energy density (ED) could be calculated using the following formula: ED (Wh/L)=E1/V.

### Example 1

### <Preparation of Separator>

A polyethylene film with a thickness of 7 μm was used as the substrate film.

Inorganic particles boehmite and a coating binder polyvinylidene fluoride were mixed at a mass ratio of 1:1, added with deionized water as a solvent, and stirred to uniformity to form an inorganic coating slurry with a solid content of 50 wt %. Dᵥ50 of the inorganic particles=0.7 μm.

The inorganic coating slurry was applied on one surface of the substrate film, dried at 90° C. to form a single layer of inorganic coating, and then the inorganic coating slurry was applied on the other surface of the substrate film, dried at 100° C. to form double layers of inorganic coatings, so as to obtain the separator. The thickness of the single layer of inorganic coating was 1 μm, and the total thickness of the inorganic coatings was 2 μm.

### <Preparation of Positive Electrode Plate>

A positive electrode active material lithium nickel cobalt manganate (Ni91, LiNi_{0.91}Co_{0.04}Mn_{0.05}O₂), a positive electrode binder polyvinylidene fluoride (PVDF, with the weight-average molecular weight of 70×10⁵), and a positive conductive agent conductive carbon black were mixed at a mass ratio of 94.8:2.8:2.4, added with N-methylpyrrolidone (NMP) as a solvent, and stirred under the action of a vacuum mixer to obtain a uniform positive slurry with a solid content of 75 wt %. The positive slurry was uniformly applied on one surface of a positive electrode current collector aluminum foil with a thickness of 13 μm, and dried at 90° C. to obtain a positive electrode plate having one surface coated with a positive electrode active material layer. The above steps were repeated on the other surface of the aluminum foil to obtain a positive electrode plate having both surfaces coated with positive electrode active material layers. After cold pressing, slitting, and welding of aluminum tabs, a positive electrode plate with specifications of 60 mm×1580 mm was obtained for later use. A compaction density of the positive electrode active material layer was 2.69 g/cm³, the thickness of the single layer of positive electrode active material layer was 38.5 μm, and the thickness of the positive electrode plate was 90 μm.

Aluminum foil grade: 5052; temper: O; and reference standard: GB/T 3198-2010 Aluminum and aluminum alloys foils.

### <Preparation of Negative Electrode Plate>

A negative electrode active material artificial graphite, a thickener carboxymethyl cellulose (CMC, with the weight-average molecular weight of 7×10⁵), and a negative electrode binder styrene-butadiene rubber (SBR, with the weight-average molecular weight of 50×10⁵) were mixed at a mass ratio of 97:1.7:1.3, added with deionized water as a solvent, and stirred under the action of a vacuum mixer to obtain a uniform negative slurry with a solid content of 51 wt %. The negative slurry was uniformly applied on one surface of a negative electrode current collector copper foil with a thickness of 10 μm, and dried at 90° C. to obtain a negative electrode plate having one surface coated with a negative electrode active material layer. The above steps were repeated on the other surface of the copper foil to obtain a negative electrode plate having both surfaces coated with negative electrode active material layers. After cold pressing, slitting, and welding of copper tabs, a negative electrode plate with specifications of 62 mm×1600 mm was obtained for later use. A compaction density of the negative electrode active material layer was 1.6 g/cm³, the thickness of the single layer of negative electrode active material layer was 58.5 μm, and the thickness of the negative electrode plate was 127 μm.

### <Preparation of Electrolyte>

In an environment with a moisture content of less than 10 ppm, non-aqueous organic solvents ethylene carbonate (EC), diethyl carbonate (DEC), and propylene carbonate (PC) were mixed at a mass ratio of 30:40:30, then lithium hexafluorophosphate (LiPF₆) was added to the obtained non-aqueous organic solvent, dissolved and mixed to uniformity to obtain an electrolyte, with the concentration of LiPF₆ being 1 mol/L.

### <Preparation of Lithium-Ion Battery>

The positive electrode plate, separator, negative electrode plate, and separator were stacked in sequence and wound to obtain an electrode assembly. The electrode assembly was placed into a cylindrical housing and dried, and then the electrolyte was injected. Processes such as vacuum packaging, standing, formation, capacity testing, degassing, and trimming were performed to obtain a cylindrical lithium-ion battery. The cylindrical housing was made of steel.

### Examples 2 to 14

These examples were the same as Example 1 except that relevant preparation parameters were adjusted according to Table 1.

When the thickness of the substrate film or the total thickness of the inorganic coating changed, the thickness of the negative electrode plate changed accordingly, so that the volume percentage of the separator was as shown in Table 1. When the thickness of the negative electrode plate changed, the thickness of the negative electrode current collector remained unchanged, and the thickness of the single layer of negative electrode active material layer changed.

### Examples 15 to 19

These examples were the same as Example 3 except that the volume percentage of the separator was adjusted according to Table 1.

The volume percentage of the separator was changed by regulating the thickness of the negative electrode plate. When the thickness of the negative electrode plate changed, the thickness of the negative electrode current collector remained unchanged, and the thickness of the single layer of negative electrode active material layer changed.

### Example 20

This example was the same as Example 3 except that in <Preparation of positive electrode plate>, the aluminum foil had its grade adjusted to 2A11 and temper adjusted to H18 so that the tensile strength of the positive electrode current collector was as shown in Table 1.

### Example 21

This example was the same as Example 3 except that in <Preparation of positive electrode plate>, the aluminum foil had its grade adjusted to 3003 so that the tensile strength of the positive electrode current collector was as shown in Table 1.

### Example 22

This example was the same as Example 3 except that in <Preparation of positive electrode plate>, the aluminum foil had its grade adjusted to 8006 so that the tensile strength of the positive electrode current collector was as shown in Table 1.

### Example 23

This example was the same as Example 3 except that in <Preparation of positive electrode plate>, the aluminum foil had its grade adjusted to 3003 and temper adjusted to H18 so that the tensile strength of the positive electrode current collector was as shown in Table 1.

### Example 24

This example was the same as Example 3 except that in <Preparation of positive electrode plate>, the aluminum foil had its grade adjusted to 1060 so that the tensile strength of the positive electrode current collector was as shown in Table 1.

### Comparative Examples 1 to 6

These comparative examples were the same as Example 1 except that the relevant preparation parameters were adjusted according to Table 1.

When the thickness of the substrate film or the total thickness of the inorganic coating changed, the thickness of the negative electrode plate changed accordingly, so that the volume percentage of the separator was as shown in Table 1. When the thickness of the negative electrode plate changed, the thickness of the negative electrode current collector remained unchanged, and the thickness of the single layer of negative electrode active material layer changed.

The preparation parameters and performance parameters of examples and comparative examples are shown in Table 1.

TABLE 1

| | | Total | | | | | | | | |
|---|---|---|---|---|---|---|---|---|---|---|
| | Thickness | thickness | | | | | | Volume | | |
| | of | of | | | | | | percentage | Collision | |
| | substrate | inorganic | | | | | | of | test | Energy |
| | film | coating | A | B | 0.1A + | C | | separator | pass | density |
| | (μm) | (μm) | (MPa) | (N/μm) | 0.2B | (MPa) | A/C | (%) | rate | (Wh/L) |
| Example 1 | 7 | 2 | 10 | 0.3 | 1.06 | 200 | 0.05 | 9 | 14/20 | 721.4 |
| Example 2 | 9 | 2 | 11 | 0.3 | 1.16 | 200 | 0.055 | 9 | 18/20 | 718.8 |
| Example 3 | 12 | 2 | 13 | 0.3 | 1.36 | 200 | 0.065 | 9 | 19/20 | 711.2 |
| Example 4 | 15 | 2 | 15 | 0.3 | 1.56 | 200 | 0.075 | 9 | 20/20 | 706.1 |
| Example 5 | 17 | 2 | 18 | 0.3 | 1.86 | 200 | 0.09 | 9 | 17/20 | 701.0 |
| Example 6 | 19 | 2 | 20 | 0.3 | 2.06 | 200 | 0.1 | 9 | 16/20 | 696.0 |
| Example 7 | 12 | 0.5 | 13 | 0.1 | 1.32 | 200 | 0.065 | 9 | 15/20 | 716.3 |
| Example 8 | 12 | 1 | 13 | 0.2 | 1.34 | 200 | 0.065 | 9 | 18/20 | 713.7 |
| Example 9 | 12 | 3 | 13 | 0.4 | 1.38 | 200 | 0.065 | 9 | 19/20 | 708.7 |
| Example 10 | 12 | 4 | 13 | 0.6 | 1.42 | 200 | 0.065 | 9 | 20/20 | 706.1 |
| Example 11 | 12 | 6 | 13 | 0.8 | 1.46 | 200 | 0.065 | 9 | 16/20 | 703.6 |
| Example 12 | 7 | 0.5 | 10 | 0.1 | 1.02 | 200 | 0.05 | 9 | 13/20 | 731.5 |
| Example 13 | 17 | 5 | 18 | 0.7 | 1.94 | 200 | 0.09 | 9 | 15/20 | 696.0 |
| Example 14 | 19 | 6 | 20 | 0.8 | 2.16 | 200 | 0.1 | 9 | 14/20 | 688.3 |
| Example 15 | 12 | 2 | 13 | 0.3 | 1.36 | 200 | 0.065 | 6 | 18/20 | 706.1 |
| Example 16 | 12 | 2 | 13 | 0.3 | 1.36 | 200 | 0.065 | 8 | 20/20 | 716.3 |
| Example 17 | 12 | 2 | 13 | 0.3 | 1.36 | 200 | 0.065 | 14 | 18/20 | 723.9 |
| Example 18 | 12 | 2 | 13 | 0.3 | 1.36 | 200 | 0.065 | 3 | 8/20 | 701.0 |
| Example 19 | 12 | 2 | 13 | 0.3 | 1.36 | 200 | 0.065 | 20 | 7/20 | 736.6 |
| Example 20 | 12 | 2 | 13 | 0.3 | 1.36 | 250 | 0.052 | 9 | 18/20 | 713.7 |
| Example 21 | 12 | 2 | 13 | 0.3 | 1.36 | 100 | 0.13 | 9 | 20/20 | 713.7 |
| Example 22 | 12 | 2 | 13 | 0.3 | 1.36 | 80 | 0.163 | 9 | 17/20 | 713.7 |
| Example 23 | 12 | 2 | 13 | 0.3 | 1.36 | 500 | 0.026 | 9 | 10/20 | 713.7 |
| Example 24 | 12 | 2 | 13 | 0.3 | 1.36 | 40 | 0.325 | 9 | 11/20 | 713.7 |
| Comparative | 3 | 2 | 6 | 0.3 | 0.66 | 200 | 0.03 | 9 | 5/20 | 741.7 |
| example 1 | | | | | | | | | | |
| Comparative | 22 | 2 | 26 | 0.3 | 2.66 | 200 | 0.13 | 9 | 5/20 | 645.2 |
| example 2 | | | | | | | | | | |
| Comparative | 12 | 0 | 13 | 0.05 | 1.31 | 200 | 0.065 | 9 | 6/20 | 718.8 |
| example 3 | | | | | | | | | | |
| Comparative | 12 | 8 | 13 | 1.2 | 1.54 | 200 | 0.065 | 9 | 5/20 | 680.7 |
| example 4 | | | | | | | | | | |
| Comparative | 3 | 0.02 | 6 | 0.05 | 0.61 | 200 | 0.03 | 9 | 6/20 | 713.7 |
| example 5 | | | | | | | | | | |
| Comparative | 22 | 7 | 26 | 1.1 | 2.82 | 200 | 0.13 | 9 | 4/20 | 698.5 |
| example 6 | | | | | | | | | | |

From Examples 1 to 19 and Comparative examples 1 to 6, it can be seen that regulating the tensile strength in transverse direction A of the separator and the puncture strength B of the separator within the ranges of this application and making the tensile strength in transverse direction A and puncture strength B of the separator satisfy 1.02≤0.1A+0.2B≤2.16 enable the secondary battery of the embodiments of this application to have higher collision test pass rate and energy density, indicating that the secondary battery of this application can have its collision test pass rate increased while taking into account the energy density. For the secondary battery in each comparative example, at least one of the tensile strength in transverse direction A of the separator, the puncture strength B of the separator, or the value of 0.1A+0.2B was not within the ranges of this application, which leads to a lower collision test pass rate and fails to increase the collision test pass rate of the secondary battery while taking into account the energy density of the secondary battery.

The tensile strength in transverse direction A of the separator generally affects the collision test pass rate and energy density of the secondary battery. It can be seen from Examples 1 to 6, Comparative example 1, and Comparative example 2 that the secondary battery using the separator with the tensile strength in transverse direction A falling within the range of this application has higher collision test pass rate and energy density.

The puncture strength B of the separator generally affects the collision test pass rate and energy density of the secondary battery. It can be seen from Example 3, Examples 7 to 11, Comparative example 3, and Comparative example 4 that the secondary battery using the separator with the puncture strength B falling within the range of this application has higher collision test pass rate and energy density.

The value of 0.1A+0.2B generally affects the collision test pass rate and energy density of the secondary battery. It can be seen from Examples 1 to 14 and Comparative examples 1, 2, 5, and 6 that the secondary battery with the value of 0.1A+0.2B falling within the range of this application has higher collision test pass rate and energy density.

The volume percentage of the separator generally affects the collision test pass rate and energy density of the secondary battery. It can be seen from Example 3 and Examples 15 to 19 that the secondary battery using the separator with the volume percentage falling within the range of this application has higher collision test pass rate and energy density.

The value of A/C generally affects the collision test pass rate and energy density of the secondary battery. It can be seen from Example 3 and Examples 20 to 24 that the secondary battery with the value of A/C falling within the range of this application has higher collision test pass rate and energy density.

It should be noted that relational terms such as “first” and “second” are only used to distinguish one entity or operation from another entity or operation, and do not necessarily require or imply that there is any such actual relationship or order between these entities or operations. Terms “comprise”, “include”, or any other variations thereof are intended to cover non-exclusive inclusions, such that a process, method, article or device including a series of elements not only includes these elements, but also includes other elements which are not expressly listed, or further includes elements which are inherent to such process, method, article or device.

The embodiments in this specification are described in a related manner. For a part that is the same or similar between different embodiments, reference may be made between the embodiments. Each embodiment focuses on differences from other embodiments.

The foregoing descriptions are merely preferred embodiments of this application, but are not intended to limit this application. Any modification, equivalent replacement, or improvement made without departing from the spirit and principle of this application shall fall within the protection scope of this application.

What is claimed is:

1. A secondary battery comprising an electrode assembly; wherein the electrode assembly comprises a positive electrode plate, a negative electrode plate, and a separator provided between the positive electrode plate and the negative electrode plate; wherein
a tensile strength in transverse direction of the separator is A MPa, a puncture strength of the separator is B N/μm, 1.02≤0.1A+0.2B≤2.16, 10≤A≤20, and 0.1≤B≤0.8.

2. The secondary battery according to claim 1, wherein 1.1≤0.1A+0.2B≤1.6.

3. The secondary battery according to claim 1, wherein 11≤A≤15.

4. The secondary battery according to claim 1, wherein 0.2≤B≤0.6.

5. The secondary battery according to claim 1, wherein the positive electrode plate comprises a positive electrode current collector, a tensile strength of the positive electrode current collector is C MPa, and 0.048≤A/C≤0.25.

6. The secondary battery according to claim 5, wherein 80≤C≤250.

7. The secondary battery according to claim 1, wherein based on a volume of the electrode assembly, a volume percentage of the separator is 6% to 14%.

8. The secondary battery according to claim 1, wherein based on a volume of the electrode assembly, a volume percentage of the separator is 7% to 10%.

9. The secondary battery according to claim 1, wherein the separator comprises a substrate film and an inorganic coating provided on at least one surface of the substrate film; wherein
the substrate film comprises at least one of polypropylene or polyethylene;
the inorganic coating comprises inorganic particles and a coating binder; wherein the inorganic particles comprise at least one of aluminum oxide, boehmite, titanium dioxide, silicon dioxide, zirconium dioxide, tin dioxide, magnesium hydroxide, magnesium oxide, zinc oxide, barium sulfate, boron nitride, or aluminum nitride; and the coating binder comprises at least one of polyvinylidene fluoride, polyacrylic acid, polymethyl methacrylate, polybutyl acrylate, or polyacrylonitrile.

10. The secondary battery according to claim 9, wherein a thickness of the substrate film is 7 μm to 19 μm, and a total thickness of the inorganic coating is 0.5 μm to 7 μm.

11. The secondary battery according to claim 10, wherein the thickness of the substrate film is 9 μm to 15 μm; and/or
the total thickness of the inorganic coating is 1 μm to 4 μm.

12. An electronic apparatus, comprising a secondary battery, the secondary battery comprising an electrode assembly; wherein the electrode assembly comprises a positive electrode plate, a negative electrode plate, and a separator provided between the positive electrode plate and the negative electrode plate; wherein
a tensile strength in transverse direction of the separator is A MPa, a puncture strength of the separator is B N/μm, 1.02≤0.1A+0.2B≤2.16, 10≤A≤20, and 0.1≤B≤0.8.

13. The electronic apparatus according to claim 12, wherein 1.1≤0.1A+0.2B≤1.6.

14. The electronic apparatus according to claim 12, wherein 11≤A≤15.

15. The electronic apparatus according to claim 12, wherein 0.2≤B≤0.6.

16. The electronic apparatus according to claim 12, wherein the positive electrode plate comprises a positive electrode current collector, a tensile strength of the positive electrode current collector is C MPa, and 0.048≤A/C≤0.25.

17. The electronic apparatus according to claim 16, wherein 80≤C≤250.

18. The electronic apparatus according to claim 12, wherein based on a volume of the electrode assembly, a volume percentage of the separator is 6% to 14%.

19. The electronic apparatus according to claim 12, wherein based on a volume of the electrode assembly, a volume percentage of the separator is 7% to 10%.

20. The electronic apparatus according to claim 12, wherein the separator comprises a substrate film and an inorganic coating provided on at least one surface of the substrate film; wherein
the substrate film comprises at least one of polypropylene or polyethylene;
the inorganic coating comprises inorganic particles and a coating binder; wherein the inorganic particles comprise at least one of aluminum oxide, boehmite, titanium dioxide, silicon dioxide, zirconium dioxide, tin dioxide, magnesium hydroxide, magnesium oxide, zinc oxide, barium sulfate, boron nitride, or aluminum nitride; and the coating binder comprises at least one of polyvinylidene fluoride, polyacrylic acid, polymethyl methacrylate, polybutyl acrylate, or polyacrylonitrile.
